(19) United States
(12) Patent Application Publication
(10) Pub. No.: US 2026/0327741 A1
(43) Pub. Date: Oct. 22, 2026

(54) METHOD FOR RECOVERING NICKEL, COBALT, AND MANGANESE, AND METHOD FOR PRODUCING VALUABLE METAL

(71) Applicant: JFE STEEL CORPORATION, Tokyo (JP)

(72) Inventors: Yotaro INOUE, Tokyo (JP); Yuta HINO, Tokyo (JP); Katsunori TAKAHASHI, Tokyo (JP)

(73) Assignee: JFE STEEL CORPORATION, Tokyo (JP)

(21) Appl. No.: 19/109,753

(22) PCT Filed: Jul. 27, 2023
(86) PCT No.: PCT/JP2023/027515

§ 371 Date: Mar. 7, 2025

(30) Foreign Application Priority Data
Sep. 13, 2022 (JP) 2022-145079

(51) Int. Cl. C22B 7/00; C22B 23/02; C22B 47/00; H01M 10/54

(52) U.S. Cl. CPC C22B 7/001; C22B 7/007; C22B 23/021; C22B 47/00; H01M 10/54

(57) ABSTRACT

Provided is a method for recovering nickel, cobalt, and manganese from compounds including metal oxides of nickel, cobalt, and manganese in such a manner that a recovered material contains a low concentration of manganese and high concentrations of nickel and cobalt.

The method for recovering nickel, cobalt, and manganese includes a mixing step of mixing compounds including a metal oxide of nickel, a metal oxide of cobalt, and a metal oxide of manganese, with a reducing agent to form a mixture; and a heating step of heating the mixture to produce a first product and a second product having a higher manganese concentration than the first product. The reducing agent used in the mixing step is at least one reducing agent selected from carbon reducing agents containing carbon as a constituent element, silicon reducing agents containing silicon as a constituent element, and aluminum reducing agents containing aluminum as a constituent element. The reducing agent is used in an amount satisfying a predetermined range.

### CROSS-REFERENCE TO RELATED APPLICATIONS

This application is a national stage application of PCT Application No. PCT/JP2023/027515, which was filed Jul. 27, 2023, and which claims foreign priority to JP2022-145079, filed Sep. 13, 2022. These prior applications are hereby incorporated by reference in their entireties.

### TECHNICAL FIELD

This disclosure relates to a nickel, cobalt, and manganese recovery method for recovering nickel, cobalt, and manganese from, for example, spent lithium ion batteries, and to a method for producing a valuable metal.

### BACKGROUND

In recent years, the demand for lithium ion batteries has increased rapidly due to the spread of mobile terminals, such as smartphones and notebook computers, and the spread of electric vehicles. Furthermore, electric vehicles that do not use fossil fuels will be increasingly demanded in the future from the point of view of cutting greenhouse gas emissions. Thus, a much higher future demand for lithium ion batteries is expected.

In general, a lithium ion battery includes a positive electrode material, a negative electrode material, a separator insulating the positive electrode and the negative electrode, and an electrolyte. The positive electrode materials are compounds containing, for example, nickel, cobalt, and manganese. Examples of such compounds of nickel, cobalt, and manganese include LiNiO₂, LiCoO₂, and LiMnO₂.

Nickel, cobalt, and manganese resources are not abundant worldwide. Therefore, the recovery of nickel, cobalt, and manganese from positive electrode materials of spent lithium ion batteries is very important from the points of view of recovery and effective use of the resources.

Compounds contained in positive electrode materials are reused by being reduced. The reduction of positive electrode materials is largely categorized into two types: wet processing and dry processing. In wet processing, powdered positive electrode materials are dissolved in an acidic solution, and nickel, cobalt, and manganese are recovered by, for example, solvent extraction or electrolytic refining.

An example of the wet processing is disclosed in Patent Literature 1, in which positive electrode materials of lithium ion batteries are brought into contact with an acid to cause the target metals to leach out, and nickel, cobalt, and manganese are recovered by multiple solvent extraction steps.

In dry processing, a mixture of powdered positive electrode materials and a reducing agent is heated to reduce nickel, cobalt, and manganese, and these metals are separated from the mixture and recovered.

As an example of the dry processing, Patent Literature 2 discloses a valuable element recovery method that includes a mixing step of mixing materials recovered from secondary batteries with a reducing agent and a flux, and a reducing step of heating and reducing the mixture.

### CITATION LIST

### Patent Literature

PTL 1: Japanese Unexamined Patent Application Publication No. 2016-186113
PTL 2: Japanese Unexamined Patent Application Publication No. 2021-95628

### SUMMARY

### Technical Problem

Unfortunately, the wet process has a limited amount that can be treated at one time and requires a long processing time. Thus, the wet process has a room for improvement in terms of efficiency in metal recovery. Furthermore, the wet process involves reagents, such as acids and solvents, and is therefore extremely high in processing cost.

By the way, metal recovered by dry processing is sometimes wet treated to increase the purities of the respective metals that are recovered. However, the manner of manganese recovery by wet processing varies depending on the form of manganese dissolved in the acidic solution. The metal recovered by the dry process disclosed in Patent Literature 2 contains manganese, and thus the subsequent wet process requires complicated treatments.

This disclosure has been made in view of the problems discussed above. It is therefore an object of the preferred embodiments to provide, in an aspect, a method for recovering nickel, cobalt, and manganese from compounds including metal oxides of nickel, cobalt, and manganese in such a manner that a recovered material contains a low concentration of manganese and high concentrations of nickel and cobalt.

### Solution to Problem

In order to achieve the object, the present disclosure has the following features.

[1]

A method for recovering nickel, cobalt, and manganese, the method including:
a mixing step of mixing compounds including a metal oxide of nickel, a metal oxide of cobalt, and a metal oxide of manganese, with a reducing agent to form a mixture; and
a heating step of heating the mixture to produce a first product and a second product having a higher manganese concentration than the first product,
wherein the reducing agent used in the mixing step is at least one reducing agent selected from carbon reducing agents containing carbon as a constituent element, silicon reducing agents containing silicon as a constituent element, and aluminum reducing agents containing aluminum as a constituent element, the reducing agent being used in an amount satisfying the following range:

(0.30a−0.15b+0.60)×X(Ni)≤R≤(0.33a−0.17b+0.67)×X(Ni)+(0.33a−0.17b+0.67)×X(Co)+(0.23a−0.12b+0.47)×X(Mn)
R: amount (mol) of the reducing agent
X (Ni): amount (mol) of nickel in the compounds
X (Co): amount (mol) of cobalt in the compounds
X (Mn): amount (mol) of manganese in the compounds
a: molar ratio (mol/mol) of a carbon reducing agent in the reducing agent
b: molar ratio (mol/mol) of a silicon reducing agent in the reducing agent.
   [2]

The method for recovering nickel, cobalt, and manganese according to [1], further comprising a compounds recovery step of recovering the compounds including the metal oxide of nickel, the metal oxide of cobalt, and the metal oxide of manganese from a lithium ion battery.

[3]

The method for recovering nickel, cobalt, and manganese according to [1] or [2], wherein the heating step is performed at 1400° C. or above.

[4]

The method for recovering nickel, cobalt, and manganese according to any one of [1] to [3], further comprising: a dissolving step of dissolving the first product obtained in the heating step into an acid to form a solution; and
an extraction step of performing solvent extraction on the solution obtained in the dissolving step.
   [5]

A method for producing a metal, wherein the metal comprises at least one element selected from nickel, cobalt, and manganese is produced from a material recovered using the method for recovering nickel, cobalt, and manganese described in any one of [1] to [4].

### Advantageous Effects

According to the present disclosure, the heating step provides a first product and a second product having a higher manganese concentration than the first product. Thus, nickel and cobalt can be recovered with high efficiency by wet processing the first product. Furthermore, manganese can be recovered with high efficiency by wet processing the second product. That is, nickel, cobalt, and manganese can be recovered by simple operations from compounds including metal oxides of nickel, cobalt, and manganese. Furthermore, efficient production of metals is realized.

### BRIEF DESCRIPTION OF DRAWING

FIG. 1 is a flow chart schematically illustrating a method for recovering metals according to the present disclosure.

### DESCRIPTION OF EMBODIMENTS

Hereinbelow, embodiments of the present disclosure will be described in detail.

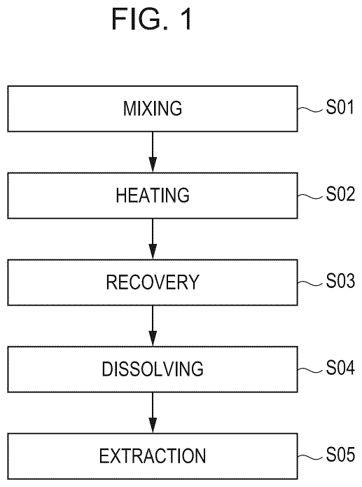

As illustrated in FIG. 1, a method for recovering nickel, cobalt, and manganese according to the present disclosure includes a mixing step (step S01) in which compounds including a metal oxide of nickel, a metal oxide of cobalt, and a metal oxide of manganese are mixed together with a reducing agent capable of reducing the metal oxide of nickel, the metal oxide of cobalt, and the metal oxide of manganese, thereby forming a mixture; a heating step (step S02) in which the mixture is heated to produce a first product and a second product having a higher manganese concentration than the first product; and a recovery step (step S03) in which slag and the metal resulting from the heating step are separated and are each recovered.

Examples of the compounds including a metal oxide of nickel, a metal oxide of cobalt, and a metal oxide of manganese include positive electrode materials from spent lithium ion batteries. The present embodiment illustrates positive electrode materials from lithium ion batteries as the compounds including a metal oxide of nickel, a metal oxide of cobalt, and a metal oxide of manganese.

That is, the method for recovering nickel, cobalt, and manganese preferably includes a compounds recovery step in which compounds including a metal oxide of nickel, a metal oxide of cobalt, and a metal oxide of manganese are recovered from a lithium ion battery. The spent lithium ion batteries are batteries that have been manufactured as rechargeable batteries and been collected, regardless of the state of use. For example, the spent lithium ion batteries may be batteries whose charging capacity has decreased to or below a predetermined value after repeated charging and discharging, or may be unused rechargeable batteries that have been collected.

A lithium ion battery includes a positive electrode material, a negative electrode material, a separator insulating the positive electrode and the negative electrode, and an electrolyte. The positive electrode materials include compounds containing, for example, nickel, cobalt, and manganese. Examples of such compounds of nickel, cobalt, and manganese include LiNiO₂, LiCoO₂, and LiMnO₂.

A positive electrode material is recovered from a lithium ion battery as follows. First, an electrolyte stored in the battery body is removed. Next, the positive electrode material is separated from the battery body. The positive electrode material separated from the battery body is crushed and then ground into a powder.

The amount (mol) of nickel, the amount (mol) of cobalt, and the amount (mol) of manganese in compounds as positive electrode materials are written as follows, respectively:
X (Ni): amount (mol) of nickel in the compounds
X (Co): amount (mol) of cobalt in the compounds
X (Mn): amount (mol) of manganese in the compounds

The amount (mol) of nickel, the amount (mol) of cobalt, and the amount (mol) of manganese in the compounds may be measured by, for example, fluorescent X-ray analysis.

In the mixing step S01, compounds obtained from positive electrode materials as described above are mixed together with a reducing agent to form a mixture. The reducing agent used here is at least one reducing agent selected from carbon reducing agents containing carbon as a constituent element, silicon reducing agents containing silicon as a constituent element, and aluminum reducing agents containing aluminum as a constituent element.

Examples of the carbon reducing agents include graphite, coal, and coke.

Examples of the silicon reducing agents that may be used include ferrosilicon, metallic silicon, and silicon sludge.

Examples of the aluminum reducing agents that may be used include elemental aluminum, aluminum sludge, and aluminum dross.

The heating step S02 is performed by heating a compact of the mixture with a heater. The compact may be obtained by filling a molding container with the mixture obtained in the mixing step and applying a pressure to the molding container. The heating step S02 gives metal as a first product, and slag as a second product having a higher manganese concentration than the first product.

For example, the heater may be an electric resistance furnace, a high-frequency melting furnace, a low-frequency melting furnace, a rotary kiln, a shaft furnace, or a steelmaking furnace.

It is recommended that the mixture is heated in an inert gas atmosphere. Examples of the inert gases that may be used include Ar and N₂. A reducing gas may be used in place of the inert gas. Examples of the reducing gases that may be used include CO and H₂.

It is recommended that the heating temperature is equal to or higher than the melting point of the compounds including a metal oxide of nickel, a metal oxide of cobalt, and a metal oxide of manganese. In consideration of heating efficiency of an electric arc furnace, the heating temperature is preferably 1400 to 1600° C., more preferably 1450 to 1600° C., and even more preferably 1450 to 1550° C. When positive electrode materials recovered from lithium ion batteries are treated at the above heating temperature, lithium carbonate is formed by the decomposition reaction of the positive electrode materials. The formed lithium carbonate is brought to or above the melting point by heating and is liquified to cause difficult handling. In the present embodiment, in contrast, lithium is present as oxide and its melting point is 500° C. or more higher than that of lithium carbonate. In the present embodiment, the lithium oxide migrates to the slag while maintaining its form. Thus, the present embodiment is free from the handling problem stemming from liquefaction.

The reduction reaction takes place at a higher rate as the heating temperature is increased. Thus, increasing the heating temperature allows the heating step to complete in a short time. Incidentally, heating at a temperature above 1600° C. invites a risk of the evaporation loss of nickel and cobalt. Thus, the heating temperature is preferably 1600° C. or below.

In the recovery step S03, the metal as the first product and the slag as the second product obtained in the heating step S02 are separated from each other, and the metal and the slag are each recovered.

Next, nickel and cobalt are separated from the metal obtained in the heating step S02. Specifically, for example, a dissolving step (step S04) is performed in which the metal is dissolved into an acid, such as sulfuric acid, followed by an extraction step (step S05) in which the solution of the metal is subjected to solvent extraction. In the extraction step S05, solvent extraction is performed using an extractant and the solvent containing cobalt is back-extracted.

For example, the extractant used here may be a phosphonic acid ester extractant. From the point of view of, for example, the efficiency in separation of nickel and cobalt, the phosphonic acid ester extractant is preferably 2-ethylhexyl 2-ethylhexylphosphonate (product name: PC-88A or Ionquest 801).

Furthermore, the solution after cobalt extraction is subjected to solvent extraction using an extractant, and the solvent containing nickel is back-extracted.

For example, the extractant used here may be a carboxylic acid extractant. Examples of the carboxylic acid extractants include neodecanoic acid and naphthenic acid.

For example, manganese may be recovered from the slag by reheating the slag and reducing the melt using carbon, silicon, or aluminum as a reducing agent, thereby collecting metallic manganese.

The presence of manganese in metal makes wet processing extremely complicated because manganese takes various forms. It is therefore desirable that metal to be wet processed have a low concentration of manganese. In the method for recovering nickel, cobalt, and manganese of the present embodiment, the heating step gives metal as the first product having a lower manganese concentration than the slag as the second product. Thus, nickel and cobalt can be recovered with high efficiency by wet processing the first product. Furthermore, manganese can be recovered with high efficiency by wet processing the second product. That is, nickel, cobalt, and manganese can be recovered by simple operations from compounds including metal oxides of nickel, cobalt, and manganese.

It is preferable that a metal including at least one element selected from nickel, cobalt, and manganese be produced from a material recovered using the above method for recovering nickel, cobalt, and manganese.

### EXAMPLES

Next, the effects of the method for recovering nickel, cobalt, and manganese of the present disclosure will be described in detail based on Examples and Comparative Examples.

### Test Example 1: Test Using Carbon Reducing Agent

Compounds including metal oxides of nickel, cobalt, and manganese, and a carbon reducing agent were mixed, and the mixtures were heated to analyze the metal components that were obtained.

As the compounds including metal oxides of nickel, cobalt, and manganese, a sample was used that contained 1 mol each of Nio, Coo, and MnO. Furthermore, coke, a carbon reducing agent, was used as the reducing agent.

### (Mixing Step)

According to the formulations described in Table 1, mixtures representing Examples Nos. 1 to 6 were prepared by adding the carbon reducing agent in the range of 0.9 to 2.7 mol to the sample. Similarly, mixtures representing Comparative Examples Nos. 7 to 9 were prepared by adding 0.7 mol or 3.0 to 4.0 mol of the carbon reducing agent to the sample.

### (Heating Step)

The mixture obtained in the mixing step was added to fill a molding container. The mixture was compacted by applying an external pressure to the molding container. The heating step was performed for 3 hours in an Ar gas atmosphere using an electric resistance furnace as a heater. In the heating step, the temperature of the electric resistance furnace was maintained at 1450° C.

### (Component Analysis)

Slag formed as the second product in the heating step was removed, and the metal as the first product was recovered. The metal components in the first product were analyzed using a fluorescent X-ray analyzer. The results of the component analysis are described in Table 1. The reduction ratio was calculated as the amount of the component in the recovered metal relative to the amount of the component in the ingredient before heating.

TABLE 1

| | | Amounts (mol) in mixture | | | | | | | | |
|---|---|---|---|---|---|---|---|---|---|---|
| | | before heating | | | | | | | | |
| | | | | | Carbon | Components (mol %) in | | | | Reduction |
| | | | | | reducing | recovered metal | | | | ratio (%) |
| Nos. | Remarks | NiO | CoO | MnO | agent | Ni | Co | Mn | C | Ni |
| 1 | Examples | 1.00 | 1.00 | 1.00 | 0.90 | 88.9 | 11.1 | 0.0 | 0.0 | 85 |
| 2 | | 1.00 | 1.00 | 1.00 | 1.00 | 90.0 | 10.0 | 0.0 | 0.0 | 94 |
| 3 | | 1.00 | 1.00 | 1.00 | 1.50 | 66.7 | 33.3 | 0.0 | 0.0 | 96 |
| 4 | | 1.00 | 1.00 | 1.00 | 2.00 | 50.0 | 45.0 | 5.0 | 0.0 | 96 |
| 5 | | 1.00 | 1.00 | 1.00 | 2.50 | 46.5 | 46.5 | 7.0 | 0.0 | 97 |
| 6 | | 1.00 | 1.00 | 1.00 | 2.70 | 45.5 | 45.5 | 9.1 | 0.0 | 99 |
| 7 | Comparative | 1.00 | 1.00 | 1.00 | 0.70 | 100.0 | 0.0 | 0.0 | 0.0 | 70 |
| 8 | Examples | 1.00 | 1.00 | 1.00 | 3.00 | 35.6 | 35.6 | 28.5 | 0.3 | 98 |
| 9 | | 1.00 | 1.00 | 1.00 | 4.00 | 32.8 | 32.8 | 32.8 | 1.6 | 99 |

As described in Table 1, the metals recovered after the heating step in Examples Nos. 1 to 6 had a manganese concentration of 9.1 mol % or less and a Ni reduction ratio of 85% or more.

In Comparative Examples Nos. 7 to 9, in contrast, the manganese concentration in the metal recovered after the heating step was 28.5 mol % or more or the Ni reduction ratio was 70%.

As shown above, Examples achieved a low manganese concentration in the metal recovered after the heating step compared with Comparative Examples. Furthermore, the Ni reduction ratios in Examples were higher than those in Comparative Examples.

Based on the results of this test example, 2.7 mol may be regarded as the upper limit of the amount R of the reducing agent in this test example. Here, the present inventors assumed that the upper limit of the amount R of the reducing agent would be expressed as X (Ni)+X (Co)+α (C)×X (Mn) and thereby obtained α (C)=0.7. When the amount R of the reducing agent is too small, Nio is not reduced and nickel is contained in the slag after the heating step, with the result that the metal recovered after the heating step contains less nickel.

When the amount R of the reducing agent was 0.7 mol, the Ni reduction ratio was as low as 70%, and 30% of NiO was separated as slag, with the result that the metal recovered after the heating step contained less nickel.

When the amount R of the reducing agent was 0.9 mol or more, the Ni reduction ratio was as high as 85% or more and the amount of NiO separated as slag was small. Thus, 0.9 mol was taken as the lower limit of the amount R of the reducing agent in this experiment. Here, the present inventors assumed that the lower limit would be expressed as β (C)×X (Ni) and thereby obtained β (C)=0.9.

In order to efficiently recover not only Ni but also Co, the amount R of the reducing agent is appropriately 2 mol or more. This lower limit value of the amount R of the reducing agent corresponds to X (Ni)+X (Co).

### Test Example 2: Test Using Silicon Reducing Agent

Compounds including metal oxides of nickel, cobalt, and manganese, and a silicon reducing agent were mixed, and the mixtures were heated to analyze the metal components that were obtained.

As the compounds including metal oxides of nickel, cobalt, and manganese, a sample was used that contained 1 mol each of Nio, CoO, and MnO. Furthermore, metallic silicon, a silicon reducing agent, was used as the reducing agent.

### (Mixing Step)

According to the formulations described in Table 2, mixtures representing Examples Nos. 10 to 15 were prepared by adding the silicon reducing agent in the range of 0.45 to 1.35 mol to the sample. Similarly, mixtures representing Comparative Examples Nos. 16 to 18 were prepared by adding 0.35 to 2.00 mol of the silicon reducing agent to the sample.

The heating step and the component analysis were performed in the same manner as in Test Example 1. The results of the component analysis are described in Table 2.

TABLE 2

| | | Amounts (mol) in mixture | | | | | | | | |
|---|---|---|---|---|---|---|---|---|---|---|
| | | before heating | | | | | | | | |
| | | | | | Silicon | Components (mol %) in | | | | Reduction |
| | | | | | reducing | recovered metal | | | | ratio (%) |
| Nos. | Remarks | NiO | CoO | MnO | agent | Ni | Co | Mn | Si | Ni |
| 10 | Examples | 1.00 | 1.00 | 1.00 | 0.45 | 83.3 | 16.7 | 0.0 | 0.0 | 86 |
| 11 | | 1.00 | 1.00 | 1.00 | 0.50 | 85.0 | 15.0 | 0.0 | 0.0 | 93 |
| 12 | | 1.00 | 1.00 | 1.00 | 0.75 | 66.7 | 33.3 | 0.0 | 0.0 | 95 |
| 13 | | 1.00 | 1.00 | 1.00 | 1.00 | 50.0 | 42.5 | 7.5 | 0.0 | 97 |
| 14 | | 1.00 | 1.00 | 1.00 | 1.25 | 45.7 | 45.7 | 6.9 | 1.8 | 99 |
| 15 | | 1.00 | 1.00 | 1.00 | 1.35 | 44.4 | 44.4 | 8.9 | 2.2 | 98 |
| 16 | Comparative | 1.00 | 1.00 | 1.00 | 0.35 | 100.0 | 0.0 | 0.0 | 0.0 | 70 |
| 17 | Examples | 1.00 | 1.00 | 1.00 | 1.50 | 34.5 | 34.5 | 27.6 | 3.5 | 97 |
| 18 | | 1.00 | 1.00 | 1.00 | 2.00 | 28.6 | 28.6 | 28.6 | 14.3 | 98 |

The results of the component analysis are described in Table 1. As described in Table 1, the metals recovered after the heating step in Examples Nos. 10 to 15 had a manganese concentration of 8.9 mol % or less and a Ni reduction ratio of 86% or more.

In Comparative Examples Nos. 16 to 18, in contrast, the manganese concentration in the metal recovered after the heating step was 27.6 mol % or more or the Ni reduction ratio was 70%.

As shown above, Examples achieved a low manganese concentration in the metal recovered after the heating step compared with Comparative Examples. Furthermore, the Ni reduction ratios in Examples were higher than those in Comparative Examples.

Based on the results of this test example, 1.35 mol may be regarded as the upper limit of the amount R of the reducing agent in this experiment. Here, the present inventors assumed that the upper limit of the amount R of the reducing agent would be expressed as 0.50×X (Ni)+0.50×X (Co)+α (Si)×X (Mn) and thereby obtained α (Si)=0.35. If the amount R of the reducing agent is too small, NiO is not reduced and nickel is contained in the slag after the heating step, with the result that the metal recovered after the heating step contains less nickel.

When the amount R of the reducing agent was 0.35 mol, the Ni reduction ratio was as low as 708, and 30% of NiO was separated as slag, with the result that the metal recovered after the heating step contained less nickel. When the amount R of the reducing agent was 0.45 mol or more, the Ni reduction ratio was as high as 86% or more and the amount of NiO separated as slag was small. Thus, amounts of the reducing agent of 0.45 mol or more will be appropriate.

From the foregoing, 0.45 mol was taken as the lower limit of the amount R of the reducing agent in this experiment. Here, the present inventors assumed that the lower limit of the amount R of the reducing agent would be expressed as β (Si)×X (Ni) and thereby obtained β (Si)=0.45. When the reducing agent was added in an amount R of 1.25 mol or more, the metal that was recovered contained silicon. However, silicon does not inhibit recovery in the subsequent wet processing for separating and recovering nickel and cobalt.

In order to efficiently recover not only Ni but also Co, the amount R of the reducing agent is appropriately 1 mol or more. This lower limit value of the amount R of the reducing agent corresponds to 0.50×X (Ni)+0.50×X (Co).

### Test Example 3: Test Using Aluminum Reducing Agent

Compounds including metal oxides of nickel, cobalt, and manganese, and an aluminum reducing agent were mixed, and the mixtures were heated to analyze the metal components that were obtained.

As the compounds including metal oxides of nickel, cobalt, and manganese, a sample was used that contained 1 mol each of Nio, CoO, and MnO. Furthermore, metallic aluminum, an aluminum reducing agent, was used as the reducing agent.

### (Mixing Step)

According to the formulations described in Table 2, mixtures representing Examples Nos. 19 to 24 were prepared by adding the aluminum reducing agent in the range of 0.60 to 1.80 mol to the sample. Similarly, mixtures representing Comparative Examples Nos. 25 to 27 were prepared by adding 0.47 mol or 2.00 to 2.67 mol of the aluminum reducing agent to the sample.

The heating step and the component analysis were performed in the same manner as in Test Example 1. The results of the component analysis are described in Table 3.

TABLE 3

| | | Amounts (mol) in mixture | | | | | | | | |
|---|---|---|---|---|---|---|---|---|---|---|
| | | before heating | | | | | | | | |
| | | | | | Aluminum | Components (mol %) in | | | | Reduction |
| | | | | | reducing | recovered metal | | | | ratio (%) |
| Nos. | Remarks | NiO | CoO | MnO | agent | Ni | Co | Mn | Al | Ni |
| 19 | Examples | 1.0 | 1.0 | 1.0 | 0.60 | 85.6 | 14.4 | 0.0 | 0.0 | 85 |
| 20 | | 1.0 | 1.0 | 1.0 | 0.67 | 80.0 | 20.0 | 0.0 | 0.0 | 95 |
| 21 | | 1.0 | 1.0 | 1.0 | 1.00 | 66.7 | 33.3 | 0.0 | 0.0 | 96 |
| 22 | | 1.0 | 1.0 | 1.0 | 1.34 | 50.0 | 42.5 | 7.5 | 0.0 | 96 |
| 23 | | 1.0 | 1.0 | 1.0 | 1.67 | 45.5 | 45.5 | 7.7 | 1.4 | 98 |
| 24 | | 1.0 | 1.0 | 1.0 | 1.80 | 44.1 | 44.1 | 8.8 | 3.1 | 98 |
| 25 | Comparative | 1.0 | 1.0 | 1.0 | 0.47 | 85.7 | 14.3 | 0.0 | 0.0 | 70 |
| 26 | Examples | 1.0 | 1.0 | 1.0 | 2.00 | 33.9 | 33.9 | 27.1 | 5.1 | 97 |
| 27 | | 1.0 | 1.0 | 1.0 | 2.67 | 27.3 | 27.3 | 27.3 | 18.2 | 99 |

The results of the component analysis are described in Table 1. As described in Table 1, the metals recovered after the heating step in Examples Nos. 19 to 24 had a manganese concentration of 8.8 mol % or less and a Ni reduction ratio of 85% or more.

In Comparative Examples Nos. 25 to 27, in contrast, the manganese concentration in the metal recovered after the heating step was 27.1 mol % or more or the Ni reduction ratio was 70%.

As shown above, Examples achieved a low manganese concentration in the metal recovered after the heating step compared with Comparative Examples. Furthermore, the Ni reduction ratios in Examples were higher than those in Comparative Examples.

Based on the results of this test example, 1.80 mol may be regarded as the upper limit of the amount R of the reducing agent in this experiment. Here, the present inventors assumed that the upper limit of the amount R of the reducing agent would be expressed as 0.67×X (Ni)+0.67×X (Co)+α (Al)×X (Mn) and thereby obtained α (Al)=0.47.

When the amount R of the reducing agent is too small, NiO is not reduced and nickel is contained in the slag after the heating step, with the result that the metal recovered after the heating step contains less nickel. When the amount R of the reducing agent was 0.47 mol, the Ni reduction ratio was as low as 70%, and 30% of NiO was separated as slag, with the result that the metal recovered after the heating step contained less nickel.

When the amount R of the reducing agent was 0.60 mol or more, the Ni reduction ratio was as high as 85% or more, the amount of NiO separated as slag was small, and the metal after the heating step did not contain manganese. Thus, 0.60 mol or more of the reducing agent will be appropriate.

From the foregoing, 0.60 mol was taken as the lower limit of the amount R of the reducing agent in this experiment. Here, the present inventors assumed that the lower limit of the amount R of the reducing agent would be expressed as β (Al)×X (Ni) and thereby obtained β (Al)=0.60. When the reducing agent was added in an amount R of 1.67 mol or more, the metal that was recovered contained aluminum. However, aluminum does not inhibit recovery in the subsequent wet processing for separating and recovering nickel and cobalt.

In order to efficiently recover not only Ni but also Co, the amount R of the reducing agent is appropriately 1.34 mol or more. This lower limit value of the amount R of the reducing agent corresponds to 0.67×X (Ni)+0.67×X (Co).

The appropriate ranges described above of the amount R of the reducing agent hold true also when the reducing agent is a mixture of a carbon reducing agent, a silicon reducing agent, and an aluminum reducing agent. That is, the amount R of the reducing agents appropriately satisfies (0.30a−0.15b+0.60)×X (Ni)≤R≤(0.33a−0.17b+0.67)×X (Ni)+(0.33a−0.17b+0.67)×X (Co)+(0.23a−0.12b+0.47)×X (Mn) where a is the molar ratio of carbon and b is the molar ratio of silicon in the reducing agents. This control of the amount R of the reducing agents ensures that the amount of NiO separated as slag after the heating step is small and the metal after the heating step has a low manganese concentration.

### Test Example 4: Metal Recovery Test

Compounds including a metal oxide of nickel, a metal oxide of cobalt, and a metal oxide of manganese were reduced using a carbon reducing agent, a silicon reducing agent, or an aluminum reducing agent, and the reduction ratios were calculated.

The compounds including a metal oxide of nickel, a metal oxide of cobalt, and a metal oxide of manganese were positive electrode materials recovered from spent lithium ion batteries. The positive electrode materials used in this test had been crushed and ground into a powder.

The total amount of nickel, cobalt, and manganese in the compounds was measured with a fluorescent X-ray analyzer, and the molar ratio was calculated. As a result, the total amount of nickel, cobalt, and manganese in the compounds was 0.4 mol, and the molar ratio of nickel, cobalt, and manganese was Ni:Co:Mn=6:2:2.

The amount X (Ni) of nickel in the compounds was X (Ni)=0.6×0.4=0.24 mol. Similarly, the amount X (Co) of cobalt in the compounds was X (Co)=0.2×0.4=0.08 mol. The amount X (Mn) of manganese in the compounds was X (Mn)=0.2×0.4=0.08 mol.

### (Mixing Step)

Mixtures representing Examples Nos. 28 to 45 and mixtures representing Comparative Examples Nos. 46 to 54 were prepared by mixing the compounds with a carbon reducing agent, a silicon reducing agent, or an aluminum reducing agent according to the formulations described in Table 4. Graphite was used as the carbon reducing agent. Metallic silicon was used as the silicon reducing agent. Metallic aluminum was used as the aluminum reducing agent.

The heating step and the component analysis were performed in the same manner as in Test Example 1. The results of the component analysis are described in Table 4.

TABLE 4

| | | Amounts (mol) in mixture | | | | | | | | | | | | | | |
|---|---|---|---|---|---|---|---|---|---|---|---|---|---|---|---|---|
| | | before heating | | | | | | | | | | | | | | |
| | | | | | Carbon | Silicon | Aluminum | Components (mol %) in | | | | | | Reduction | | |
| | | Ni | Co | Mn | reducing | reducing | reducing | recovered metal | | | | | | ratio (%) | | |
| Nos. | Remarks | amount | amount | amount | agent | agent | agent | Ni | Co | Mn | C | Si | Al | Ni | Co | Mn |
| 28 | Examples | 0.24 | 0.08 | 0.08 | 0.216 | 0 | 0 | 95.6 | 4.4 | 0.0 | 0.0 | — | — | 79 | 11 | 0 |
| 29 | | 0.24 | 0.08 | 0.08 | 0.240 | 0 | 0 | 97.3 | 2.7 | 0.0 | 0.0 | — | — | 83 | 7 | 0 |
| 30 | | 0.24 | 0.08 | 0.08 | 0.280 | 0 | 0 | 85.8 | 14.2 | 0.0 | 0.0 | — | — | 99 | 49 | 0 |
| 31 | | 0.24 | 0.08 | 0.08 | 0.320 | 0 | 0 | 75.2 | 22.8 | 2.0 | 0.0 | — | — | 100 | 91 | 8 |
| 32 | | 0.24 | 0.08 | 0.08 | 0.360 | 0 | 0 | 72.1 | 24.3 | 3.6 | 0.0 | — | — | 99 | 100 | 15 |
| 33 | | 0.24 | 0.08 | 0.08 | 0.376 | 0 | 0 | 71.9 | 23.5 | 4.6 | 0.0 | — | — | 100 | 98 | 19 |
| 34 | | 0.24 | 0.08 | 0.08 | 0 | 0.108 | 0 | 94.2 | 5.8 | 0.0 | — | 0.0 | 0.0 | 76 | 14 | 0 |
| 35 | | 0.24 | 0.08 | 0.08 | 0 | 0.120 | 0 | 93.7 | 6.3 | 0.0 | — | 0.0 | 0.0 | 84 | 17 | 0 |
| 36 | | 0.24 | 0.08 | 0.08 | 0 | 0.140 | 0 | 86.0 | 14.0 | 0.0 | — | 0.0 | 0.0 | 98 | 48 | 0 |
| 37 | | 0.24 | 0.08 | 0.08 | 0 | 0.160 | 0 | 75.0 | 21.7 | 3.3 | — | 0.0 | 0.0 | 99 | 86 | 13 |
| 38 | | 0.24 | 0.08 | 0.08 | 0 | 0.180 | 0 | 71.1 | 23.2 | 3.3 | — | 2.4 | 0.0 | 100 | 98 | 14 |
| 39 | | 0.24 | 0.08 | 0.08 | 0 | 0.188 | 0 | 69.1 | 22.8 | 4.6 | — | 3.5 | 0.0 | 100 | 99 | 20 |
| 40 | | 0.24 | 0.08 | 0.08 | 0 | 0 | 0.144 | 94.7 | 5.3 | 0.0 | — | — | 0.0 | 77 | 13 | 0 |
| 41 | | 0.24 | 0.08 | 0.08 | 0 | 0 | 0.160 | 92.3 | 7.7 | 0.0 | — | — | 0.0 | 80 | 20 | 0 |
| 42 | | 0.24 | 0.08 | 0.08 | 0 | 0 | 0.188 | 85.7 | 14.3 | 0.0 | — | — | 0.0 | 100 | 50 | 0 |
| 43 | | 0.24 | 0.08 | 0.08 | 0 | 0 | 0.212 | 75.0 | 21.3 | 3.8 | — | — | 0.0 | 100 | 85 | 15 |
| 44 | | 0.24 | 0.08 | 0.08 | 0 | 0 | 0.240 | 69.4 | 23.1 | 3.9 | — | — | 3.5 | 100 | 100 | 17 |
| 45 | | 0.24 | 0.08 | 0.08 | 0 | 0 | 0.252 | 65.9 | 22.0 | 4.4 | — | — | 7.7 | 100 | 100 | 20 |
| 46 | Comparative | 0.24 | 0.08 | 0.08 | 0.168 | 0 | 0 | 100.0 | 0.0 | 0.0 | 0.0 | — | — | 69 | 0 | 0 |
| 47 | Examples | 0.24 | 0.08 | 0.08 | 0.400 | 0 | 0 | 62.2 | 20.5 | 17.0 | 0.3 | — | — | 100 | 99 | 82 |
| 48 | | 0.24 | 0.08 | 0.08 | 0.480 | 0 | 0 | 58.3 | 19.4 | 19.4 | 2.9 | — | — | 100 | 100 | 100 |
| 49 | | 0.24 | 0.08 | 0.08 | 0 | 0.084 | 0 | 100.0 | 0.0 | 0.0 | — | 0.0 | — | 70 | 0 | 0 |
| 50 | | 0.24 | 0.08 | 0.08 | 0 | 0.200 | 0 | 58.6 | 19.3 | 16.2 | — | 5.9 | — | 100 | 99 | 82 |
| 51 | | 0.24 | 0.08 | 0.08 | 0 | 0.240 | 0 | 48.8 | 16.3 | 16.3 | — | 18.7 | — | 100 | 100 | 100 |
| 52 | | 0.24 | 0.08 | 0.08 | 0 | 0 | 0.112 | 94.7 | 5.3 | 0.0 | — | — | 0.0 | 60 | 10 | 0 |
| 53 | | 0.24 | 0.08 | 0.08 | 0 | 0 | 0.268 | 54.1 | 18.0 | 14.4 | — | — | 13.5 | 100 | 100 | 80 |
| 54 | | 0.24 | 0.08 | 0.08 | 0 | 0 | 0.320 | 36.0 | 12.0 | 12.0 | — | — | 40.0 | 100 | 100 | 100 |

As described in Table 4, the reducing agent that was used in Nos. 28 to 33 was the carbon reducing agent. In this case, the suitable amount R (mol) of the reducing agent is obtained by 0.90×X (Ni)≤R≤X (Ni)+X (Co)+0.70×X (Mn). That is, the amount R (mol) of the reducing agent is suitably 0.216 mol≤R≤0.376 mol.

Examples Nos. 28 to 33 in which the amount R of the reducing agent was within the above range achieved 79% or higher nickel reduction ratio. These Examples also attained a low manganese concentration, 4.6% or less, in the recovered metal.

In contrast, Comparative Example No. 46 in which the amount R of the reducing agent was below the above range resulted in a nickel reduction ratio of 69%, which was lower than the values obtained in the above Examples. Furthermore, the amount of nickel metal recovered in Comparative Example No. 46 was smaller than the amount recovered in each of the above Examples. Comparative Examples Nos. 47 and 48 involved the reducing agent in an amount R larger than the above range. Comparative Examples Nos. 47 and 48 attained 100% nickel reduction ratio but resulted in a manganese concentration in the metal of 17% or more, which was higher than the values obtained in Examples Nos. 28 to 33.

As described in Table 4, the reducing agent that was used in Nos. 34 to 39 was the silicon reducing agent. In this case, the suitable amount R (mol) of the reducing agent is obtained by 0.45×X (Ni)≤R≤0.5×X (Ni)+0.5×X (Co)+0.35×X (Mn). That is, the amount R (mol) of the reducing agent is suitably 0.108 mol≤R≤0.188 mol.

Examples Nos. 34 to 39 in which the amount R of the reducing agent was within the above range achieved a high nickel reduction ratio of 76% or more and also attained a low manganese concentration, 4.6% or less, in the recovered metal.

In contrast, Comparative Example No. 49 in which the amount R of the reducing agent was below the above range resulted in a low nickel reduction ratio of 70% and recovered less nickel metal. Comparative Examples Nos. 50 and 51 involved the reducing agent in an amount R larger than the above range. Comparative Examples Nos. 50 and 51 attained 100% nickel reduction ratio but resulted in a manganese concentration in the metal of 16% or more, which was higher than the values obtained in Examples Nos. 34 to 39.

As described in Table 4, the reducing agent that was used in Nos. 40 to 45 was the aluminum reducing agent. In this case, the suitable amount R (mol) of the reducing agent is obtained by 0.60×X (Ni)≤R≤0.67×X (Ni)+0.67×X (Co)+0.47×X (Mn). That is, the amount R (mol) of the reducing agent is suitably 0.144 mol≤R≤0.252 mol.

Examples Nos. 40 to 45 in which the amount R of the reducing agent was within the above range achieved a high nickel reduction ratio of 77% or more and also attained a low manganese concentration, 4.4% or less, in the recovered metal.

In contrast, Comparative Example No. 52 in which the amount R of the reducing agent was below the above range resulted in a low nickel reduction ratio of 60% and recovered less nickel metal. Comparative Examples Nos. 53 and 54 involved the reducing agent in an amount R larger than the above range. Comparative Examples Nos. 53 and 54 attained 100% nickel reduction ratio but resulted in a manganese concentration in the metal of 12% or more, which was higher than the values obtained in Examples Nos. 40 to 45.

1. A method for recovering nickel, cobalt, and manganese, the method comprising:
a mixing step of mixing compounds including a metal oxide of nickel, a metal oxide of cobalt, and a metal oxide of manganese, with a reducing agent to form a mixture; and
a heating step of heating the mixture to produce a first product and a second product having a higher manganese concentration than the first product,
wherein the reducing agent used in the mixing step is at least one reducing agent selected from carbon reducing agents containing carbon as a constituent element, silicon reducing agents containing silicon as a constituent element, and aluminum reducing agents containing aluminum as a constituent element, the reducing agent being used in an amount satisfying the following range:
(0.30a−0.15b+0.60)×X(Ni)≤R≤(0.33a−0.17b+0.67)×X(Ni)+(0.33a−0.17b+0.67)×X(Co)+(0.23a−0.12b+0.47)×X(Mn)
R: amount (mol) of the reducing agent
X (Ni): amount (mol) of nickel in the compounds
X (Co): amount (mol) of cobalt in the compounds
X (Mn): amount (mol) of manganese in the compounds
a: molar ratio (mol/mol) of a carbon reducing agent in the reducing agent
b: molar ratio (mol/mol) of a silicon reducing agent in the reducing agent.

2. The method for recovering nickel, cobalt, and manganese according to claim 1, further comprising a compounds recovery step of recovering the compounds including the metal oxide of nickel, the metal oxide of cobalt, and the metal oxide of manganese from a lithium ion battery.

3. The method for recovering nickel, cobalt, and
manganese according to claim 1, wherein the heating step is performed at 1400° C. or above.

4. The method for recovering nickel, cobalt, and manganese according to claim 1, further comprising:
a dissolving step of dissolving the first product obtained in the heating step into an acid to form a solution; and
an extraction step of performing solvent extraction on the solution obtained in the dissolving step.

5. (canceled)

6. The method for recovering nickel, cobalt, and manganese according to claim 2, further comprising:
a dissolving step of dissolving the first product obtained in the heating step into an acid to form a solution; and
an extraction step of performing solvent extraction on the solution obtained in the dissolving step.

7. The method for recovering nickel, cobalt, and manganese according to claim 3, further comprising:
a dissolving step of dissolving the first product obtained in the heating step into an acid to form a solution; and
an extraction step of performing solvent extraction on the solution obtained in the dissolving step.

8. (canceled)

9. A method for producing a valuable metal, wherein a valuable metal including at least one element selected from nickel, cobalt, and manganese is produced from a material recovered using the method for recovering nickel, cobalt, and manganese described in claim 1.

10. A method for producing a valuable metal, wherein a valuable metal including at least one element selected from nickel, cobalt, and manganese is produced from a material recovered using the method for recovering nickel, cobalt, and manganese described in claim 2.

11. A method for producing a valuable metal, wherein a valuable metal including at least one element selected from nickel, cobalt, and manganese is produced from a material recovered using the method for recovering nickel, cobalt, and manganese described in claim 3.

12. A method for producing a valuable metal, wherein a valuable metal including at least one element selected from nickel, cobalt, and manganese is produced from a material recovered using the method for recovering nickel, cobalt, and manganese described in claim 4.

13. (canceled)

14. A method for producing a valuable metal, wherein a valuable metal including at least one element selected from nickel, cobalt, and manganese is produced from a material recovered using the method for recovering nickel, cobalt, and manganese described in claim 6.

15. A method for producing a valuable metal, wherein a valuable metal including at least one element selected from nickel, cobalt, and manganese is produced from a material recovered using the method for recovering nickel, cobalt, and manganese described in claim 7.

16. A method for producing a valuable metal, wherein a valuable metal including at least one element selected from nickel, cobalt, and manganese is produced from a material recovered using the method for recovering nickel, cobalt, and manganese described in claim 8.

17. The method for recovering nickel, cobalt, and manganese according to claim 2, wherein the heating step is performed at 1400° C. or above.

18. The method for recovering nickel, cobalt, and manganese according to claim 17, further comprising:
a dissolving step of dissolving the first product obtained in the heating step into an acid to form a solution; and
an extraction step of performing solvent extraction on the solution obtained in the dissolving step.

19. A method for producing a valuable metal, wherein a valuable metal including at least one element selected from nickel, cobalt, and manganese is produced from a material recovered using the method for recovering nickel, cobalt, and manganese described in claim 17.
